(19) United States
(12) Patent Application Publication
(10) Pub. No.: US 2014/0273988 A1
(43) Pub. Date: Sep. 18, 2014

(54) METHOD FOR SCHEDULING PHONE CALLS

(71) Applicant: Yakov Z. Mermelstein, Spring Valley, NY (US)

(72) Inventor: Yakov Z. Mermelstein, Spring Valley, NY (US)

(21) Appl. No.: 13/804,525

(22) Filed: Mar. 14, 2013

(51) Int. Cl. H04W 4/16

(52) U.S. Cl. CPC H04W 4/16
USPC 455/414.1

(57) ABSTRACT

The herein method for facilitating scheduling of phone calls involves establishing electronic communications between participants of the phone call. One participant sends a notice of an intent to have a phone call. Then there is a search of the electronic calendars of these participants to identify open times where both are available for a phone call. Thereafter, the system searches electronic calendars of the participants to identify the location of each participant during these open times, Finally, it verifies that each of the participants is available at a suitable location for the phone call at those open times.

### FIELD OF THE INVENTION

This invention relates to the electronics and communications industry and, more particularly, to a method for scheduling phone calls.

### BACKGROUND OF THE INVENTION

One of the little annoying problems in life is arranging calls with people. Sometimes it becomes a case of “telephone tag.” First one person calls and leaves a message. Then, the other returns the call, only to find that the first person is now unavailable.

There are programs and application software to find a common time slot between two people. The problem with these programs is that they do not take into account a person's location. For example, a person may have an open time slot, but he is on the train traveling somewhere, so he cannot conveniently speak to someone else. While his time slot is marked “available,” he is not really available, because he is not at a location where he can properly participate in the call.

Therefore, there is a need in the industry for a method to more efficiently schedule phone calls, taking into account a person's location.

### SUMMARY OF THE INVENTION

These and other objects of the invention are achieved with a method involving electronically searching each person's electronic calendar to find a compatible time for a call, and at the same time verifying that each is at an appropriate location for participating in the call.

According to the Invention, the method for facilitating scheduling of phone calls, comprises: Establishing electronic communications between participants of said phone call; One participant sending a notice of an intent to have a phone call; Searching electronic calendars of said participants to identify open times where both are available for a phone call; Searching electronic calendars of said participants to identify a location of each participant during said open times; and Verifying that each of said participants is available at a suitable location for said phone call at said open times.

According to an additional embodiment, the method further includes: Monitoring the geographic location of each participant; Determining if each participant is at a suitable location for said phone call; and Alerting each participant when all said participants are at a suitable location for said phone call.

Other objects, features and advantages of the present invention will become apparent upon reading the following detailed description in conjunction with the drawings and the claims.

### BRIEF DESCRIPTION OF THE DRAWINGS

For a better understanding of the invention, its operation and specific objects attained by its uses, reference should be had to accompanying drawings and descriptive matter in which there are illustrated preferred embodiments of the invention

The invention will now be described in connection with certain preferred embodiments with reference to the following illustrative figures so that it may be more fully understood.

FIG. 1 is a flow chart, showing the process of the invention.

FIG. 2 is a flow chart, showing an additional feature of the process of the invention.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

According to the Invention, in its simplest, basic form, it involves searching the electronic calendars of two phone participants to find a common available time, taking into consideration the location of each person. A time slot is not truly available unless a person is at a suitable location for participating in the call.

In the preferred embodiment of the invention, the method for facilitating scheduling of phone calls, comprises: Establishing electronic communications between participants of said phone call; One participant sending a notice of an intent to have a phone call; Searching electronic calendars of said participants to identify open times where both are available for a phone call; Searching electronic calendars of said participants to identify a location of each participant during said open times; and Verifying that each of said participants is available at a suitable location for said phone call at said open times.

According to an additional embodiment, the method further includes: Monitoring the geographic location of each participant; Determining if each participant is at a suitable location for said phone call; and Alerting each participant when all said participants are at a suitable location for said phone call.

Calendaring software is software that minimally provides users with an electronic version of a calendar. Additionally, the software may provide an appointment book, address book, and/or contact list. These tools are an extension of many of the features provided by time management software such as desk accessory packages and computer office automation systems. Calendaring is a standard feature of many PDAs, EDAs, and smart phones.

The software may be a local package designed for individual use or may be a networked package that allows for the sharing of information between users. It is this type of calendaring software that is needed with the herein method.

The flow of the process is shown in FIG. 1 herein

Firstly, for the herein system to work, there must be electronic communications between the participants. This may be by a local area network (such as an intra-office network) or by means of the Internet.

Then, there must be electronic calendars that are accessible to each other. Each person must be able to initiate a request to the other to set up a time for a phone meeting.

Another requirement is that each participant needs to set his location on his electronic calendar. Without this information this system will not work. To facilitate use of this system, the electronic calendars may have a default setting. If the user does not set a location for a particular day, then a predefined default location is used, such as the user's home city.

Once the system determines there is a common time slot for a phone call, it next refers to the location of each participant. Each needs to be in a suitable location for the phone call. For example, if the person is on public transport (such as a plane or train or bus) or a hotel or restaurant or someone else's office, there may not be the required privacy needed for the call. Thus, even the person may not actually have anything planned at that time, he is still not available for the call because he cannot talk freely at the location where he is.

Therefore, one feature of the herein system is that it evaluates the location to determine if is suitable.

A location may be suitable for some types of calls, but not for others.

In a public location, a person may not want to speak to his banker or stock broker and mention his private financial matters in public. On the other hand if the phone discussion is just to discuss, for example, delivery of ordered merchandise, it may not matter.

Some locations may not be suitable if they are too loud, and you cannot hear the phone conversation. For example, if the user is at a sports event or concert, phone conversation may effectively impossible because he cannot hear.

Users may want to block out certain times on their calendars as unavailable even though they have no meetings per se. For example, they may block out time that they are at religious services.

Additionally, participants may specify their status. For example, their calendar may show for certain times status notes, like, inter alia, busy, not available, on vacation, etc. The unavailable option has a lot of factors like—travel time, business/personal, on the phone, location, activity (walking), public transportation, driving, home, only at my desk, etc.

Availability can be set manually and/or automatically. More specifically, the participant can proactively set his calendar for certain times to indicate his availability or non-availability. Alternatively, the system may do so automatically, based on prior entries on the electronic calendar. For example, during business trips, the calendar may indicate unavailability for certain types of calls.

Therefore, the status of participants is indicated on their respective electronic calendars.

It may be appreciated that each participant may have his own standard for availability. The automatic availability option can be set at the preference by each individual differently for the same activity. For example, one might set he is unavailable while walking on the street, and a second person may indicate he is available while walking on the street.

Sometimes, a participant may designate alternate contact details for a specified time. This may occur, for example, when the person is on vacation or on a vacation. He may want to designate an alternate phone or e mail that may be more convenient.

The invention also contemplates that advance notice may be given of the expected content or subject matter of the call. In particular, a participant can send a notice to arrange a phone call, including relevant details about the subject matter of the phone call. It may indicate whether or not the call is business related or personal. If desired, the recipient can have the option to reject the call.

It is contemplated that a participant may reject having the phone call. For example, a person who received the invitation for the phone call may decide he does not want to have the call, for whatever reason, and simply reject having the call.

Another option is that either participant may invite additional persons to join the phone call. In that event, the process repeats itself, but for all the participants, including checking all their electronic calendars for availability, both regarding time and location, as heretofore mentioned.

The duration of the phone call may be specified by either person. Either may change the duration at any time. More specifically, you have a option to set a duration time for this call while sending the invitation and/or adding or changing while accepting the call invitation.

An invitation for a phone call may be prioritized with respect to other entries on a person's electronic calendar. In other words, just like appointments and meeting are designated with a priority, so may phone calls. There can be an option to rank the phone call request by the requester and separately by the receiver. Each may prioritize it differently.

One other aspect is that the due date for the call may be indicated. In other words, either party may designate the date by which the call must be made. For example, if a decision on an order must be made by 1 May, the due date for the call may be 30 April. Hence, the notice of an intent to have a phone call may include a date by which the call must be made.

The system contemplates that each person will be accessing their electronic calendar through a portable electronic device like a smart phone, a tablet, PDAs, etc. For optimum use of the herein invention, the personal electronic device, according to the Invention, includes some type of a global position system (GPS), which will identify the physical location of the device, and thereby the person. In particular, the term Global Positioning System should also include any communication system that helps the device determine its location, and it is not limited to and may include “WIFI,” “Bluetooth,” “NFC” and/or “GPS.”

In a preferred embodiment, a GPS chip would be part of the electronic device so that the device always knows the person's location. Thus, by means of the GPS chip, the system can determine the person's location and then can verify that each of the participants is available at a suitable location for the phone call at the open times.

According to the additional embodiment (FIG. 2), a GPS chip (or other technology) is necessary to determine the locations of the participants. By means of this GPS chip, it is possible to monitor the geographic location of each participant.

Further, any other suitable means may be used to determine the position of the person. Hence, “WIFI,” “Bluetooth,” or “NFC” may be used and not just “GPS.” The invention contemplates any means that may be used to monitor his movements so we can know if he is at rest or at walk.

Thereafter, the system determines if each participant is at a suitable location for said phone call.

When the system determines that each person is at a suitable location, it alerts all the participants that everyone is currently available for the phone call.

It will be evident to those skilled in the art that the invention is not limited to the details of the foregoing illustrative embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

I claim:

1. A method for facilitating scheduling of phone calls, comprising:
A. Establishing electronic communications between participants of said phone call;
B. A first participant sending a notice of an intent to have a phone call;
C. Searching electronic calendars of said participants to identify open times where both are available for a phone call;
D. Searching electronic calendars of said participants to identify a location of each participant during said open times; and
E. Verifying that each of said participants is available at a suitable location for said phone call at said open times.

2. A method according to claim 1, further comprising:
F. Monitoring the geographic location of each participant;
G. Determining if each participant is at a suitable location for said phone call; and
H. Alerting each participant when all said participants are at a suitable location for said phone call.

3. A method according to claim 1, wherein participants specify certain times as being unavailable.

4. A method according to claim 1, wherein status of participants is indicated on their respective electronic calendars.

5. A method according to claim 4, wherein said status of participants is indicated by the participants.

6. A method according to claim 1, wherein a participant may designate alternate contact details for a specified time.

7. A method according to claim 1, further comprising a participant sending a notice to arrange a phone call, including relevant details about subject matter of said phone call.

8. A method according to claim 1, wherein a participant may reject having said phone call.

9. A method according to claim 1, further comprising inviting additional persons to join the phone call.

10. A method according to claim 1, wherein duration of said phone call is specified.

11. A method according to claim 1, wherein an invitation for a phone call may be prioritized with respect to other entries on a person's electronic calendar.

12. A method according to claim 1, wherein said notice of an intent to have a phone call may include a date by which the call must be made.

13. A method according to claim 2, wherein said monitoring the geographic location of each participant being effected by “WIFI,” “Bluetooth,” “NFC” and/or “GPS.
